(19) United States
(12) Patent Application Publication
(10) Pub. No.: US 2005/0152126 A1
(43) Pub. Date: Jul. 14, 2005

(54) Electroluminescent cable assembly and electroluminescent cable constructions included therein

(75) Inventor: Itzhak Hadar, Zikhron Yaakov (IL)

Correspondence Address: G.E. EHRLICH (1995) LTD.;c/o ANTHONY CASTORINA, SUITE 207, 2001 JEFFERSON DAVIS HIGHWAY, ARLINGTON, VA, 22202, US

(73) Assignee: Teldor Wires & Cables Ltd.

(21) Appl. No.: 10/754,591

(22) Filed: Jan. 12, 2004

(51) Int. Cl. F21V 9/16

(52) U.S. Cl. 362/84

(57) ABSTRACT

An electroluminescent cable assembly, includes a reel constructed for winding an electroluminescent cable thereon; an electroluminescent cable wound on the reel; a supporting member rotatably mounting the reel for permitting the electroluminescent cable to be deployed therefrom; and a self-contained power supply carried by the reel so as to be rotated therewith for supplying electrical power to the electroluminescent cable when deployed from the reel.

### FIELD AND BACKGROUND OF THE INVENTION

The present invention relates to electroluminescent cable assemblies, namely to cable assemblies which include electroluminescent fibers having a phosphor which generates light when subjected to an electrical field. The invention also relates to electroluminescent cable constructions particularly useful in such assemblies.

Electroluminescent cables are well known and are gaining increasing usage where it is desired to produce a linear light source for various purposes, such as for marking-off defined areas, for building decoration, for advertising, for providing lighted directions or names, etc. Examples of known types of electroluminescent cable constructions are described in various publications including U.S. Pat. Nos. 3,819,973; 5,869,930; and 5,876,863; and International Publication Nos. WO 01/41511 published Jun. 7, 2001, and WO 02/48605, published Jun. 20, 2002, the contents of which publications are incorporated herein by reference.

Electroluminescent cables are energized by AC power. The requirement for AC power thus limits the use of such cables since electrical power is not always available at a particular site where it may be desired to deploy the electroluminescent cable.

### OBJECTS AND BRIEF SUMMARY OF THE INVENTION

An object of the present invention is to provide a novel electroluminescent cable assembly which may readily be used almost anywhere desired for marking-off, decoration, advertising, or other purpose. Another object of the present invention is to provide an electroluminescent cable assembly which permits the convenient transportation and deployment of the electroluminescent cable as and where desired. A further object of the present invention is to provide a novel electroluminescent cable construction for selectively emitting either visible light or infra-red non-visible light.

According to one aspect of the present invention, there is provided an electroluminescent cable assembly, comprising: a reel constructed for winding an electroluminescent cable thereon; an electroluminescent cable wound on the reel; a supporting member rotatably supporting the reel such as to permit the electroluminescent cable to be deployed therefrom; and a self-contained power supply carried by the reel so as to be rotated therewith for supplying electrical power to the electroluminescent cable when deployed from the reel.

According to further features in the preferred embodiments of the invention described below, the self-contained power supply includes: a rechargeable battery for providing a DC voltage; and an inverter for converting the DC voltage of the battery to AC for powering the electroluminescent cable when deployed from the reel.

More particularly, in the described preferred embodiment, the reel includes a drum having an outer surface over which the electroluminescent cable is wound. The rechargeable battery is mounted within the drum on one side; and the inverter is mounted within the drum on the opposite side to balance the drum during the rotation thereof.

According to still further features in the described preferred embodiment, the outer surface of the drum is formed with a lead-through opening receiving one end of the electroluminescent cable for connection to the self-contained power supply. In addition, one end of the drum is closed by a cover fixed to the drum and carrying a central shaft rotatably mounting the drum, and the opposite end of the drum is closed by a cover removable from the drum to provide access to the self-contained power supply within the drum.

In the described preferred embodiment, the supporting member is a stand having a pair of legs for stably resting the reel drum on a flat horizontal surface. In addition, the assembly further comprises: mounting plate having attaching elements engageable with the pair of legs of the stand for attaching and detaching the reel drum with respect to the mounting plate. The mounting plate in the described preferred embodiment is a back plate, such as used in backpacks, and includes a body harness attached to the back plate facilitating transporting the reel to a desired location for deploying the electroluminescent cable thereat.

According to another aspect of the present invention, there is provided, an electroluminescent cable assembly, comprising: a reel constructed for winding an electroluminescent cable thereon; an electroluminescent cable wound on the reel; a stand rotatably mounting the reel for permitting the electroluminescent cable to be deployed, the stand having a pair of legs for stably resting the reel on a flat horizontal surface; and a mounting plate having attaching elements engageable with the pair of legs of the stand for attaching and detaching the reel with respect to the back plate. Preferably; but not necessarily, the mounting plate is a back plate and includes a body harness attached to the back plate facilitating transporting the reel to a desired location for deploying the electroluminescent cable thereat.

According to a still further aspect of the present invention, there is provided an electroluminescent cable which includes one or more electroluminescent wire elements emitting visible light when energized, and one or more infra-red wire elements emitting infra-red non-visible light when energized, the two types of wire elements being selectively energizable.

As will be described more particularly below, electroluminescent cable assemblies constructed in accordance with the foregoing features permit electroluminescent cables to be readily transported and deployed in a convenient and efficient manner at almost any location where electroluminescent lighting may be desired.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is an end view illustrating one form of electroluminescent cable assembly constructed in accordance with the present invention, wherein the electroluminescent cable is wound on a reel attached to a back plate for convenient manual transportation to any desired site at which the electroluminescent cable is to be deployed;

FIG. 2 is a three-dimensional view illustrating the reel in the assembly of FIG. 1 when detached from the back plate used for transportation purposes;

FIG. 3 is an end view of the reel of FIG. 2 with a part of the stand removed;

FIG. 4 is a side view of the reel of FIG. 2 illustrating the electroluminescent cable wound thereon;

FIG. 5 is an end view of the reel of FIG. 2 with the end cover removed to show internal structure;

FIG. 6 is a side view of the reel as shown in FIG. 5 without the electroluminescent cable;

FIG. 7 is an exploded view showing the main elements of the reel and its stand;

FIG. 8 illustrates one of the attaching members for attaching the reel of FIGS. 2-7 to the back plate in FIG. 1;

FIG. 9 is a sectional view illustrating the other attaching element for attaching the reel to the back plate;

FIG. 10 is a sectional view illustrating one construction of electroluminescent cable that may be wound on the reel;

FIGS. 11 and 12 are diagrammatic end and longitudinal views, respectively, illustrating another construction of electroluminescent cable which may be used in the above-described assembly;

FIGS. 13 and 14 are corresponding views illustrating yet another construction of electroluminescent cable which may be used in the above-described assembly;

FIG. 15 is an end view of a further construction of electroluminescent cable which may be used; and

FIGS. 16 and 17 are diagrammatic end and longitudinal views, respectively, illustrating a still further construction of electroluminescent cable which may be used in the above-described assembly.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiment described is for purposes of example only, and that the invention is capable of being embodied in other forms and applications than described herein.

### DESCRIPTION OF A PREFERRED EMBODIMENT

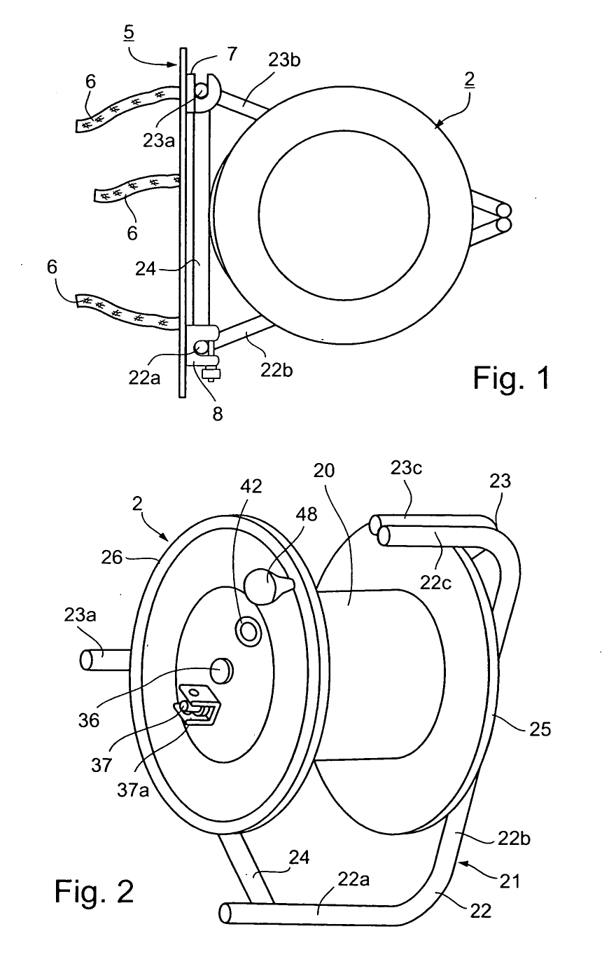

The electroluminescent cable assembly illustrated in FIG. 1 comprises a reel 2, on which is wound an electroluminescent cable 3 (FIG. 4). The reel is attached to a mounting plate, in this case a back plate 5 having a body harness 6 to enable the reel to be conveniently transported to any desired location for deployment of the electroluminescent cable. As will be described more particularly below, back plate 5 further includes attaching elements 7 and 8 which provide a convenient means for attaching the reel 2 to the back plate 5 for transportation to the deployment site, and for conveniently detaching the reel from the back plate to permit deployment of the electroluminescent cable at the desired site.

The construction of the reel 2 is more particularly illustrated in FIGS. 2-7. It includes a cylindrical drum 20 rotatably mounted on a stand 21 constituted of three frame members 22, 23 and 24. Frame members 22 and 23 are of the same construction. They include a pair of long horizontal sections 22a, 23a at one end extending parallel to each other to serve as supporting legs for the stand; a pair of upwardly-extending intermediate sections 22b, 23b, converging towards each other in the upward direction for rotatably mounting the drum 20; and a pair of parallel short horizontal sections 22c, 23c at their upper ends extending together in a side-by-side relation to serve as a convenient handle for transportation purposes. Frame member 24 is in the form of a straight bar joined at its opposite ends to the horizontal sections 22a, 23a of the two frame members 22, 23, to thereby form a sturdy stand-type frame for stably supporting the drum 20 on any flat horizontal surface, such as the ground, floor, or the like, at the site where the electroluminescent cable is to be deployed.

Drum 20, on which the electroluminescent cable 3 is wound (FIG. 4), is provided with large-diameter flanges 25, 26 at its opposite ends for conveniently receiving therebetween the electroluminescent cable when wound on the drum. The interior of drum 20 is hollow and houses a self-contained power supply, as will be described more particularly below. One end of drum 20 is formed with a feed-through opening 27, (FIG. 6), for connecting one end of the electroluminescent cable to the power supply housed within the drum.

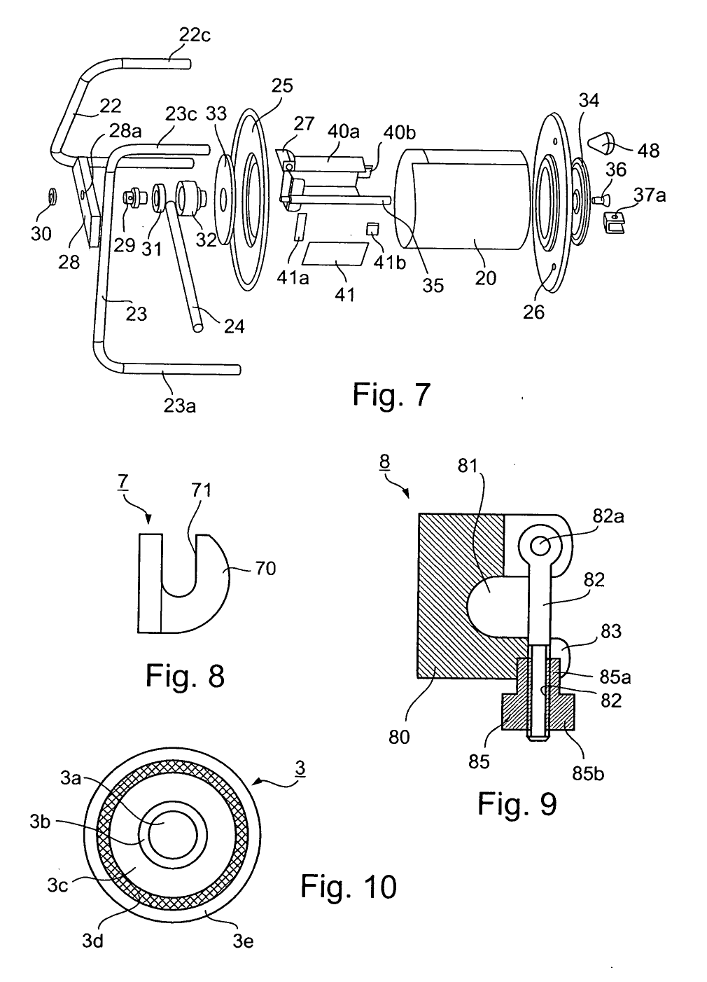

As shown particularly in FIG. 7, a bar 28 is secured to the intermediate sections 22b, 23b of the two frame members 22, 23 for rotatably mounting the drum 20. Thus, mounting bar 28 is formed with a central opening 28a for receiving the end of a shaft 29 which is locked thereto by a locking disc 30. The opposite end of shaft 29 is received within a bearing 31 rotatably mounted within a housing 32 carried centrally of an end cover 33 secured to the end flange 25 of the drum 20.

The opposite end of drum 20 is closed by a removable end cover 34 which is removably attached to flange 26 at that end of the drum by means of a center rod 35 extending through the interior of the drum and adapted to receive a screw 36 for fixing the removable cover 34 to flange 26. Thus, by removing screw 36, cover 34 may be removed from the respective end of drum 20 to provide access into the interior of the drum. As indicated earlier and as will be described more particularly below, the interior of drum 20 houses a self-contained power supply for powering the electroluminescent cable 3 wound on the drum.

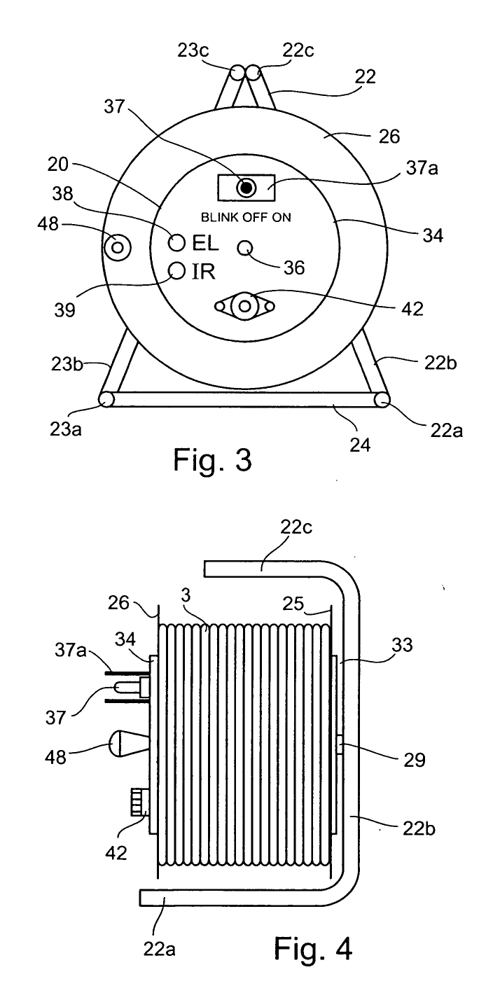

As shown particularly in FIG. 3, removable cover 34 further includes a toggle switch 37 mounted on a U-shape mounting member 37a for controlling the power supply within the drum powering the electroluminescent cable. FIG. 3 illustrates three positions of toggle switch 37, namely an “OFF” position, an “ON” position, and a “BLINK”. As shown in FIG. 3, mounting member 37a is of a U-shape configuration, permitting the toggle switch to be moved only to one of the three above positions. Straddling the toggle switch by the two walls of U-shaped member 37a also provides some protection against accidental movement of the toggle switch.

In several preferred embodiments of the invention described below, the electroluminescent cable may include one or more wire elements emitting visible light when energized, and one or more infra-red wire elements emitting infra-red, non-visible light when energized, each of the two types of wire elements being selectively energisable. In such embodiments, the cover 34 of drum 20 would include two push-button switches, shown at 38 and 39, respectively, for selecting the above wire elements of the electroluminescent cable to be energized. Both types, or either type, would be energized by the self-contained power supply within drum 20.

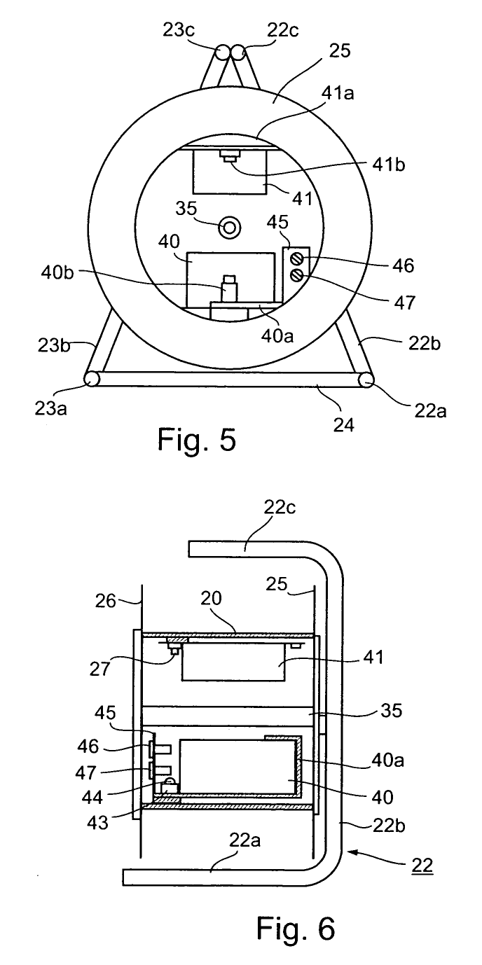

The self-contained power supply within drum 20 includes a rechargeable battery 40 (FIGS. 5 and 6) mounted in the interior of the drum at one side thereof, and an inverter 41 mounted in the interior of the drum at the diametrically opposite side thereof. As shown particularly in FIG. 7, the rechargeable battery is mounted within a housing 40a secured to a plate 40b on the inner surface of drum 20; whereas the inverter 41 is mounted on a plate 41 a by means of a fastener 41b, which plate is fixed to the inner surface of the drum at the opposite side thereof. Rechargeable battery 40 and inverter 41 rotate with drum 20. Mounting the battery and inverter at diametrically opposite sides of the drum produces a balance of forces during the rotation of the drum.

Battery 40 is rechargeable for providing a DC voltage; and inverter 41 is connected to the rechargeable battery for converting the DC voltage to AC for powering the electroluminescent cable at the deployment site. Battery 40 may be recharged, whenever desired, via a socket 42 (FIGS. 3, 4) carried by the removable cover 34.

As shown in FIGS. 5 and 6, the interior of drum 20 further includes battery fixing plate 43 fixed by a fastener 44, and a fuse base plate 45 for mounting an AC fuse housing 46, and a DC fuse housing 47.

As shown particularly in FIG. 3, the outer flange 26 of drum 20 carries, at its outer periphery, a handle 48 graspable by the user for rotating the drum around its main shaft 29 in order to pay-in and pay-out the electroluminescent cable 3 wound on the drum.

It will thus be seen that the reel 2, including the electroluminescent cable 3 wound thereon, is a self-contained unit containing its own power supply, which may be transported to any desired location and stably rested on the ground or other horizontal surface for deployment of the electroluminescent cable at that location. Back plate 5 and body harnesses 6 facilitate the transportation of the reel 2 to any desired location. Thus, body harness 6 may be applied over the shoulders of a person carrying the reel in the same manner as in a conventional backpack, and the previously-mentioned attaching elements 7 and 8 carried by back plate 5 permit the quick and convenient attachment and detachment of the reel 2 with respect to the back plate.

The construction of attaching elements 7 and 8 carried by back plate 5 is more particularly illustrated in FIGS. 8 and 9, respectively. Attaching elements 7 and 8 are constructed and located on back plate 5 so as to receive the pair of legs, (horizontal sections 22a, 23a) of the frame 21 rotatably mounting the drum 20.

Thus, as shown in FIG. 8, attaching element 7 includes an upper U-shaped member 70 fixed to back plate 5 adjacent and parallel to its upper edge. Strip 70 is formed with an open end 71 dimensioned to receive leg 23a of the frame 21 rotatably mounting drum 20.

Attaching element 8, as shown in FIG. 9, includes a lower U-shaped member 80 also fixed to back plate 5 but adjacent and parallel to its lower edge. U-shaped member 80 is open at its side 81 for receiving the other leg 22a of the reel frame 21, but that leg is locked to the backing plate by a locking device including a locking pin 82 movably mounted with respect to member 80.

More particularly, and as shown in FIG. 9, locking pin 82 is pivotally mounted at one end 82a to member 80 at one side of its open side 81. The opposite end of pin 82 is externally threaded, as shown at 82b, and is passed through a slot 83 formed in member 80 at the opposite side of its open side 81. A screw 85, having an internally threaded shank 85a and an enlarged head 85b, is passed through slot 83 with the head 85a of the screw facing outwardly so as to be conveniently grippable by a user's fingers to rotate the screw.

Screw 85 of attaching element 8 is used for locking and unlocking the frame to the back plate. Thus, when screw 85 is rotated in one direction, its shank 85a is moved into slot 83 to lock pivotal pin 82 against pivotal movement, thereby securely holding the frame leg 22a within member 80. Rotating screw 85 in the opposite direction moves its shank 85a out of slot 83, thereby permitting locking pin 82 to pivot to its open position to release the frame leg from member 80.

Electroluminescent cable 3 may of any desired construction, e.g., one of the constructions described in the above-cited publications. FIG. 10 illustrates an example of such electroluminescent cable which may be used. The illustrated example includes a central electroluminescent fiber 3a, which may be of the single or dual type, as described for example in the above-cited International Publication Nos. WO 01/41511 and WO 02/48605. Electroluminescent cable 3 would further include a first layer of insulation 3b; a second layer of insulation 3c; a transparent monofilament braiding 3d of high strength and light dispersion (e.g., of nylon); and an outer transparent jacket 3e (e.g., of polyvinyl chloride).

The electroluminescent cable assembly could take many other constructions and could be used in many diverse applications for rescue, guidance, marking, helicopter landing strips, etc. The electroluminescent cable could also be one for emitting infra-red light as well as, or in lieu of, visible light. For example, the cable assembly could include an additional wire designed to create heat when energized such that the cable will have a first mode of operation for emitting visible light, and a second mode of operation for emitting non-visible infrared light. Both modes of operation would be energized by the same power supply including the same inverter.

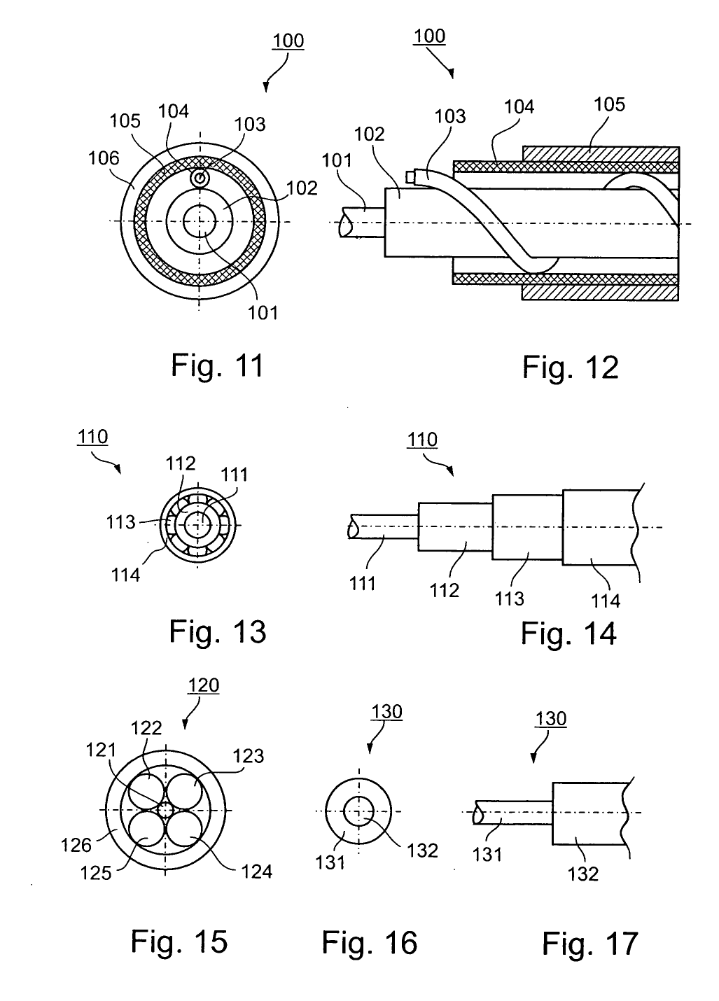

FIGS. 11-17 illustrates various constructions of the latter types of electroluminescent cables that may be used, all powered by the self-contained power supply within drum 20.

Thus, the electroluminescent cable illustrated in FIGS. 11 and 12, and therein generally designated 100, includes one or more electroluminescent wire elements 101 for generating visible light, and an electrically insulating layer 102 thereover of a transparent plastic material, e.g., polyvinylchloride. Insulating layer 102 may also include color additives. Cable 100 illustrated in FIGS. 11 and 12 further includes one or more infra-red wire elements 103 (e.g., of a nickel alloy) for emitting infra-red or heat when energized, and is coated with an insulating layer 104, such as of polyvinylchloride. Cable 100 further includes a high-strength braiding 105 of transparent monofilaments (e.g., of nylon), and is covered by an outer jacket 106 of transparent plastic material (e.g., polyvinylchloride).

The electroluminescent cable illustrated in FIGS. 13 and 14, and therein generally designated 110, includes a central infra-red wire element 111 emitting infra-red or heat energy upon being energized; a layer of plastic insulating material 112 thereover; a high-strength braiding 113 of transparent nylon monofilaments thereover; and an outer transparent jacket 114.

The cable illustrated in FIG. 15, therein generally designated 120, includes a central strength member 121 in the form of a nylon monofilament; an electroluminescent wire 122 producing visible light when energized; an infra-red wire 123 producing infra-red or heat energy when energized; another electroluminescent wire 124; another infra-red wire 125; and an outer jacket 126 of a transparent plastic material.

Electroluminescent cable illustrated in FIGS. 16 and 17, therein generally designated 130, includes an electroluminescent wire 131, and a jacket 132 of a transparent plastic material including filter additives to modify the light emitted by the electroluminescent wire 140 into the infra-red wavelength.

As indicated above, cables 100 and 120, which includes both electroluminescent wires and infra-red wires, may be selectively energized so as to emit visible light and/or non-visible infra-red radiation. The infra-red radiation may be heat radiation of the micrometer wavelength or cold light of about 800 nm wavelengths.

While the invention has been described with respect to several preferred embodiments, it will be appreciated that these are set forth merely for purposes of example, and that many other variations, modifications and applications of the invention may be made. For example, the described electroluminescent cable assembly could be mounted on a different type of mounting plate than back plate 5, e.g., a mounting plate carried by a land vehicle, aircraft, ship, submarine, etc. The assembly could be constructed for underwater use particularly since the interior of the drum is water-sealed, thereby isolating the electrical components therein from the water.

Many other variations, modifications and applications of the invention will be apparent to those skilled in the art.

1. An electroluminescent cable assembly, comprising:
a reel constructed for winding an electroluminescent cable thereon;
an electroluminescent cable wound on said reel;
a supporting member rotatably supporting said reel such as to permit said electroluminescent cable to be deployed therefrom;
and a self-contained power supply carried by said reel so as to be rotated therewith for supplying electrical power to said electroluminescent cable when deployed from said reel.

2. The assembly according to claim 1, wherein said self-contained power supply includes:
a rechargeable battery for providing a DC voltage;
and an inverter for converting the DC voltage of the battery to AC for powering said electroluminescent cable when deployed from said reel.

3. The assembly according to claim 2, wherein said reel includes a rotatable drum having an outer surface over which the electroluminescent cable is wound; said rechargeable battery being mounted within said drum on one side thereof; said inverter being mounted within said drum on the opposite side thereof to balance said drum during the rotation thereof.

4. The assembly according to claim 3, wherein the outer surface of said drum is formed with a lead-through opening receiving one end of said electroluminescent cable for connection to said self-contained power supply.

5. The assembly according to claim 3, wherein one end of said drum is closed by a cover fixed to the drum and carrying a central shaft rotatably mounting said drum, and the opposite end of said drum is closed by a cover removable from said drum to provide access to the self-contained power supply within the drum.

6. The assembly according to claim 5, wherein said removable cover is sealingly mounted to said drum and carries a manual switch electrically connected to said self-contained power supply for controlling same, and an electrical socket connected to said self-contained power supply for receiving an electrical plug connected to an external power supply for recharging said battery.

7. The assembly according to claim 5, wherein said opposite end of the drum carries a handle mounted at its outer periphery for manually rotating said drum.

8. The assembly according to claim 1, wherein said supporting member is a stand having a pair of legs for stably resting the reel on a flat horizontal surface.

9. The assembly according to claim 8, wherein said assembly further comprises: a mounting plate having attaching elements engageable with said pair of legs of the stand for attaching and detaching said reel with respect to said mounting plate.

10. The assembly according to claim 9, wherein said mounting plate is a back plate and includes a body harness attached thereto facilitating transporting the reel to a desired location for deploying the electroluminescent cable thereat.

11. The assembly according to claim 9, wherein one of said attaching elements includes an upper U-shaped member open at its upper end to receive one of said legs of the stand; and the other of said attaching elements includes a lower U-shaped member open at its side to receive the other leg of the stand; said lower U-shaped member including a locking device movable to a locking position for closing said open side; locking said other leg of the stand to the mounting plate, and to a releasing position for releasing said other leg from the mounting plate.

12. The assembly according to claim 11, wherein said movable locking device includes:
a pin pivotally mounted at one end to said lower U-shaped member at one side of its open side and threaded at its opposite end, said opposite end passing through a slot in said lower U-shaped member at the opposite side of said open side;
and a screw having a threaded shank at one end receiving said threaded end of the pin and passing through said slot in said lower U-shaped member, the opposite end of said threaded shank being formed with a head grippable by a user's fingers to rotate the screw in one direction to move the shank into said slot and thereby to lock said pin against pivotal movement, or in the opposite direction to move the shank out of said slot and thereby to release said pin for pivotal movement.

13. An electroluminescent cable assembly, comprising:
a reel constructed for winding an electroluminescent cable thereon;
an electroluminescent cable wound on said reel;
a stand rotatably mounting said reel for permitting the electroluminescent cable to be deployed, said stand having a pair of legs for stably resting the reel on a flat horizontal surface;
and a mounting plate having attaching elements engageable with said pair of legs of the stand for attaching and detaching said reel with respect to said mounting plate.

14. The assembly according to claim 13, wherein said mounting plate is a back plate and includes a body harness attached thereto facilitating transporting the reel to a desired location for deploying the electroluminescent cable thereat.

15. The assembly according to claim 13, wherein one of said attaching elements includes an upper U-shaped member open at its upper end to receive one of said legs of the stand; and the other of said attaching elements includes a lower U-shaped member open at its side to receive the other leg of the stand; said lower U-shaped member including a movable locking device movable to a locking position for closing said open side, locking the other leg of the stand to the mounting plate, and to a releasing position for releasing said other leg from the mounting plate to permit deployment of the electroluminescent cable thereof.

16. The assembly according to claim 15, wherein said movable locking device includes:
a pin pivotally mounted at one end to said lower U-shaped member at one side of its open side and threaded at its opposite end, said opposite end passing through a slot in said lower U-shaped member at the opposite side of said open side;
and a screw having a threaded shank at one end receiving said threaded end of the pin and passing through said slot in said lower U-shaped member, the opposite end of said threaded shank being formed with a head grippable by a user's fingers to rotate the screw in one direction to move the shank into said slot and thereby to lock said pin against pivotal movement, or in the opposite direction to move the shank out of said slot and thereby to release said pin for pivotal movement.

17. The assembly according to claim 13, wherein said assembly further comprises a self-contained power supply carried by said reel so as to be rotated therewith for supplying electrical power to said electroluminescent cable when deployed from said reel.

18. The assembly according to claim 17, wherein said self-contained power supply includes:
a rechargeable battery for providing a DC voltage;
and an inverter for converting the DC voltage of the battery to AC for powering said electroluminescent cable when deployed from said reel.

19. The assembly according to claim 18, wherein said reel includes a rotatable drum having an outer surface over which the electroluminescent cable is wound; said rechargeable battery being mounted within said drum on one side thereof; said inverter being mounted within said drum on the opposite side thereof to balance said drum during the rotation thereof.

20. The assembly according to claim 19, wherein one end of said drum is closed by a cover fixed to the drum and carrying a central shaft rotatably mounting said drum, and the opposite end of said drum is sealingly closed by a cover removable from said drum to provide access to the self-contained power supply within the drum.

21. The assembly according to claim 1, wherein said electroluminescent cable includes one or more electroluminescent wire elements emitting visible light when energized, and one or more infra-red wire elements emitting infra-red non-visible light when energized, each of said wire elements being selectively energizable from said self-contained power supply carried by said reel.

22. The assembly according to claim 21, wherein said electroluminescent cable further includes one or more monofilaments of a strong, transparent plastic material.

23. The assembly according to claim 21, wherein said electroluminescent cable further includes an outer transparent jacket.

24. An electroluminescent cable comprising one or more electroluminescent wire elements emitting visible light when energized, and one or more infra-red wire elements emitting infra-red non-visible light when energized, said wire elements being selectively energizable.

25. The electroluminescent cable according to claim 24, wherein said electroluminescent cable further includes one or more monofilaments of a strong, transparent plastic material.

26. The electroluminescent cable according to claim 24, wherein said electroluminescent cable further includes an outer transparent jacket.
